(19) United States
(12) Patent Application Publication
(10) Pub. No.: US 2010/0019010 A1
(43) Pub. Date: Jan. 28, 2010

(54) Organizer for tailgating activities

(76) Inventor: Daniel R. Davis, Brandywine, MD (US)

Correspondence Address: Hoffman, Wasson & Gitler, P.C., Suite 522, 2461 South Clark Street, Arlington, VA, 22202, US

(21) Appl. No.: 12/458,932

(22) Filed: Jul. 28, 2009

Related U.S. Application Data
(60) Provisional application No. 61/129,891, filed on Jul. 28, 2008.

(51) Int. Cl. B60R 9/00

(52) U.S. Cl. 224/542

(57) ABSTRACT

Organizer, formed within an internal framework of tubular aluminum secured together by pop rivets, fits into rear of pick-up truck for transport t sporting events, picnics, parties, etc. When tailgate on truck is dropped into open position, organizer, which has wheels at each corner, is rolled off truck and onto metal platform. Platform has U-shaped channels along opposite sides of upper surface, and wheels on organizer fit into channel so that organizer can be pushed onto platform with minimal effort. Once in position, doors on organizer are opened to reveal contents of diverse compartments formed within framework. Compartments are commodious, and store diverse items and supplies. After party is over, unused supplies can be returned to assigned compartments, doors are closed, and organizer is wheeled back to pick-up truck.

### CROSS-REFERENCE TO RELATED APPLICATION(S)

This application claims priority of U.S. Provisional Patent Application Ser. No. 61/129,891, filed on Jul. 28, 2008.

### FIELD OF THE INVENTION

The invention pertains to an organizer that fits into the back of a pick-up truck and carries supplies for a tailgate party or a sporting event, picnic, or the like.

### BACKGROUND OF THE INVENTION

Spectators attending a football game, NASCAR race, picnic, or other outdoor events, frequently participate in a tail-gate party with family members, friends, fellow spectators, etc. The person, or persons, hosting the tailgate party, are responsible for providing food, beer and soft drinks, ice, chairs, umbrellas, plates, utensils, and other necessary items. A considerable amount of time and effort is expended in gathering the several items required for a successful tailgate party, packing one's automotive vehicle with the items, driving the vehicle to the desired location, unpacking the items at the conclusion of the party, even more time and effort is involved in cleaning up, re-packing the unused items and driving the vehicle back to the starting point.

The need for an organizer, that can store and carry several items, of diverse shapes, sizes, and weights, to and from the site of a tailgate party, is readily apparent. The need for an organizer, that can fit into the back of a pick-up truck, and store and carry the several items necessary for a tailgate party is also apparent.

Furthermore, a stable platform to support the organizer, when removed from the back of the pick-up truck, would be highly desirable. The provision of wheels on the underside of the tailgate organizer, which would facilitate sliding the organizer out of the open end of a pick-up truck and onto the platform, would be advantageous. The process would be reversed, after the tailgate party has ended, and the organizer could be returned to its position in the pick-up truck.

Several embodiments of roll-on, roll-off receptacles, that cooperate with wheeled vehicles, such as pick-up trucks, are shown in U.S. Pat. No. 5,743,701, granted Apr. 28, 1998, to Richard Green. FIG. 10 of Green shows a roll-on, roll-off receptacle 12 that fits into the rear of a pick-up truck 10. Elevated wheels 38 rest upon support surfaces 34 on the opposite sides of the truck. The receptacle, when unloaded from the truck is supported by jacks 318 at each corner of the receptacle, as shown in FIG. 14.

### BRIEF SUMMARY OF THE INVENTION

The present invention contemplates an organizer that fits into the back of a pick-up truck for transport, to and from a party site. Once at the site, the organizer, which has wheels at each corner, is withdrawn from the truck and rides in spaced channels defined at the upper end of a stable platform located in proximity to the truck. The contents of the organizer are withdrawn, as needed. At the conclusion of the party or event, the unused items are returned to their specific compartments within the organizer. The organizer is then moved in the opposite direction, along the platform, for return to the rear of the pick-up truck. The wheels on the organizer facilitate movement of the organizer.

The resent invention further contemplates an organizer, with distinct compartments, for storing specific items, implements, or supplies, required for a tailgate party, picnic, event, etc. To illustrate, one compartment stores folding bar chairs, another compartment stores a pop-up tent, another larger compartment stores a grill-stove, a water container, plates, napkins, utensils, etc., while two insulated compartments at one side of the organizer store hot or cold food or beverages. Drains are provided for the insulated compartments, and, an area is defined below the compartments to receive a 30″×60″ foldable table, which is retained in place by a leather strap.

Also, the present invention contemplates that the organizer will rely upon a framework of lightweight, but strong, aluminum tubing. The various components will be joined to the tubing by pop-rivets. The lightweight frame allows the organizer to be moved from the pick-up truck to the platform, and vice versa, with a minimum of effort. Aluminum panels on the exterior of the organizer enclose the framework and conceal same in the interior of the organizer.

Aluminum doors are mounted for pivotal movement by piano-hinges to close the various components. The organizer is visually pleasing, and may be decorated with team logos to enhance the party atmosphere.

Other advantages and objectives realized by the organizer envisioned by the present invention will become apparent to the skilled artisan from a consideration of the following illustrations and the appended specification.

### BRIEF DESCRIPTION OF THE DRAWINGS

FIG. 1 is an elevational view of an organizer constructed in accordance with the principles of the invention, resting in the back of a pick-up truck;

FIG. 2 is a perspective view of the organizer being transferred from the pick-up truck to a platform;

FIG. 3 is a perspective view of the organizer seated upon a platform;

FIG. 4 is an elevational view of the platform;

FIG. 5 is a perspective view of the organizer seated upon the platform, with the doors of the organizer ajar;

FIG. 6 is a rear elevational view of the organizer;

FIG. 7 is a vertical cross-sectional view through the organizer;

FIG. 8 is a vertical cross-sectional view through the insulated compartments of the organizer; and

FIG. 9 is a perspective view of the aluminum framework for the organizer; the view is shown on a reduced scale;

FIG. 10 is a top plan view of the framework shown in FIG. 9; and

FIG. 11 is an end elevational view of the framework shown in FIG. 9.

### DETAILED DESCRIPTION OF THE INVENTION

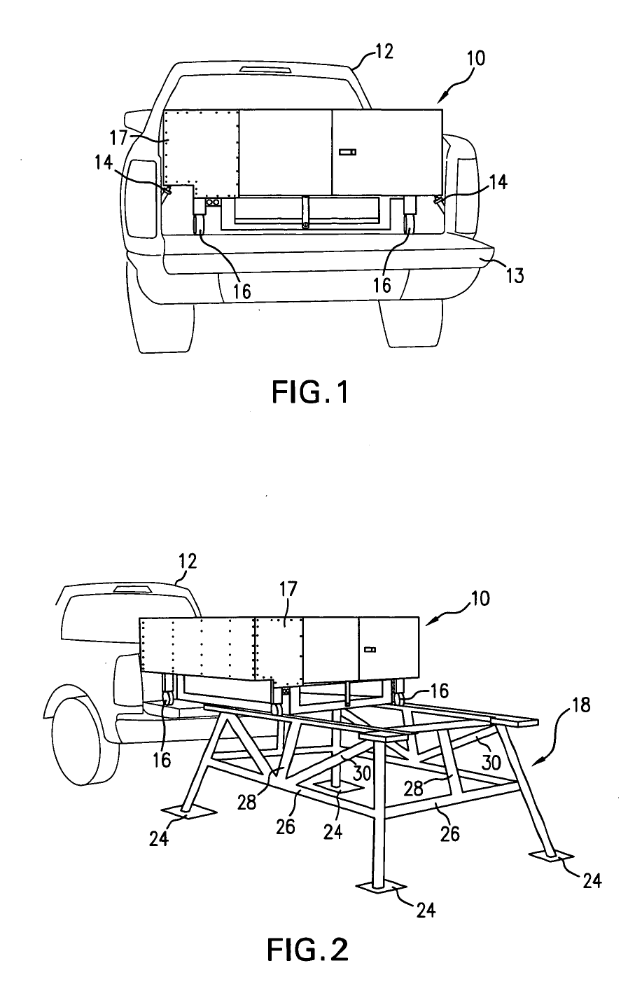

FIG. 1 shows the organizer, indicated generally by reference numeral 10, resting on bed 11 of pick-up truck 12. The tailgate 13 of truck 12 is lowered to its horizontal position, and chains, or cords, 14 return organizer 10 in fixed position on bed 11. A wheel 16 is located at each corner of organizer 10, which is rectangular in shape, when viewed from above. An external metal layer 17 encloses the organizer, and conceals an inner framework from view.

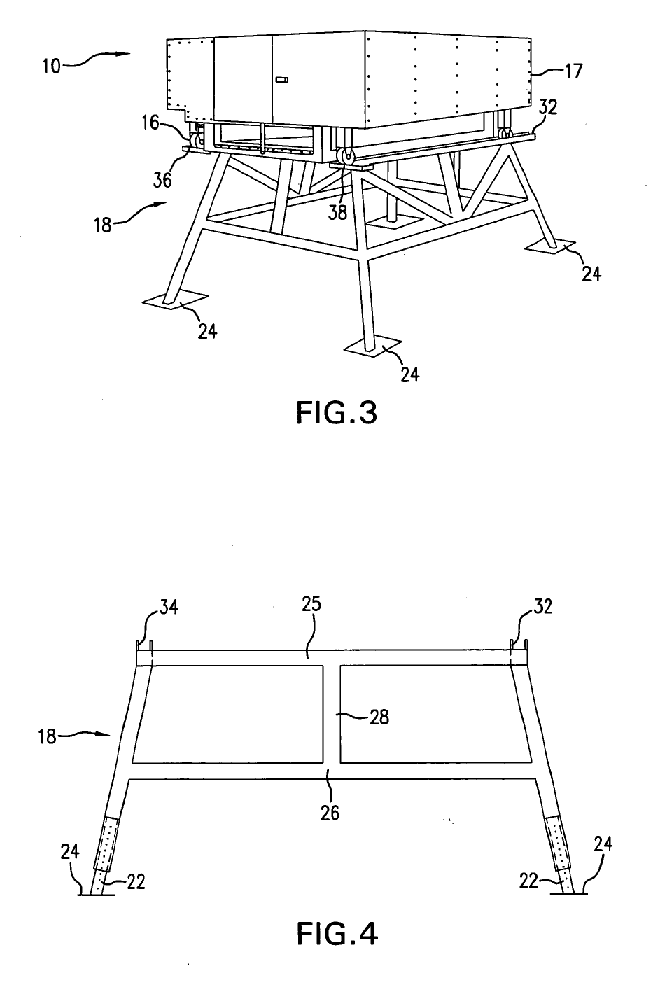

FIGS. 2-4 show a metal platform, indicated generally by reference numeral 18, that receives organizer 10, when it is slid longitudinally for off-loading from truck 12. Platform 18 includes legs 20, one leg being located at each corner of the platform. Base 22, with an enlarged pad 24, fits into leg 20, in a telescoping manner. Base 22 can be adjusted to alter the height of the upper surface 25 of platform 18 to correspond to the height of the bed of truck 12, so that the organizer can be slid onto the platform. Horizontal braces 26 join each pair of legs 20, and vertical braces 28 extend between the upper surface of platform 18 and brace 26. Diagonal struts 30 further strengthen platform 18.

Parallel, upwardly opening, U-shaped channels 32, 34 extend along the opposite sides of the upper surface of platform 18. Upturned stops 36, 38 are formed at the forward ends of channels 32, 34. The wheels 16 of organizer 10 move within channels 32, 34, until arrested by stops 36, 38.

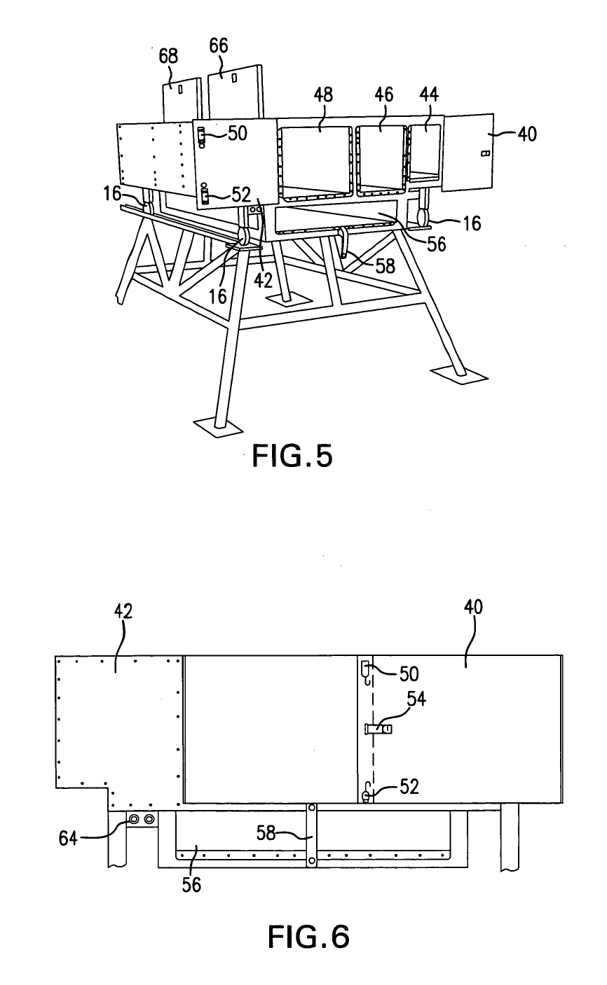

FIGS. 5-6 show organizer 10 resting upon platform 18. Doors 40, 42 have been swung open around their hinges. Door 40, when closed, seals compartments 44 and 46. Door 42, when closed, seals compartment 46. Latches 50, 52 retain door 42 in closed position; latch 54 retains door 40 in closed position. A large, rectangular storage area 56 is located below compartments 46 and 48.

Each compartment in organizer 10 is sized to receive a specific item, or items, necessary for a tailgate party. To illustrate, compartment 44 receives foldable, bag chairs, and compartment 46 receives a tent, in fold-up condition, and compartment 48 receives a stove or grill, utensils, paper plates, etc. Storage area 56 receives a fold-up table, and leather strap 58 retains the table within the compartment.

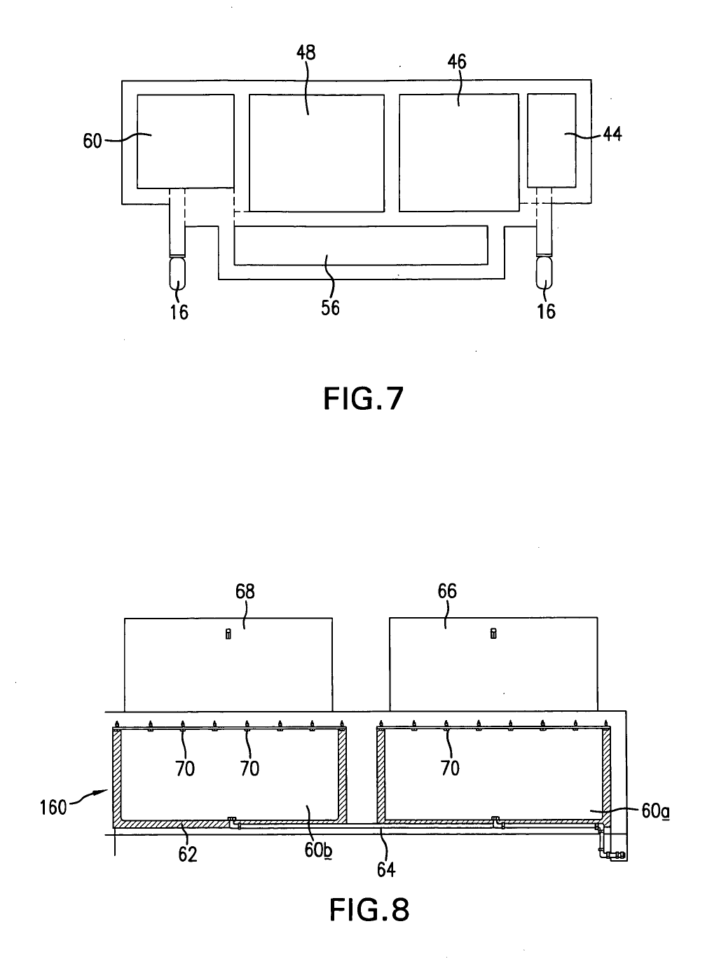

FIG. 7 shows the aluminum tubing that forms the framework for organizer 10, including the openings that define the various compartments discussed above. The outline of compartment 60, which is insulated to receive hot or cold beverages and/or hot or cold food, is visible at the left side of the framework.

FIG. 8 shows the details of insulated compartment 60, which may be divided into two smaller compartments 60a and 60b. Insulation 62 extends around the base and interior walls of compartments 60a and 60b, as well as the bottom of each compartment. Drain pipes 64 extend through both compartments, and lead fluid to the exterior of the organizer 10. The upper end of compartment 60a is sealed by pivotally mounted door 66, while the upper end of compartment 60b is sealed by pivotally mounted door 68. The insulation is secured to the aluminum framework by screws or pop rivets 70.

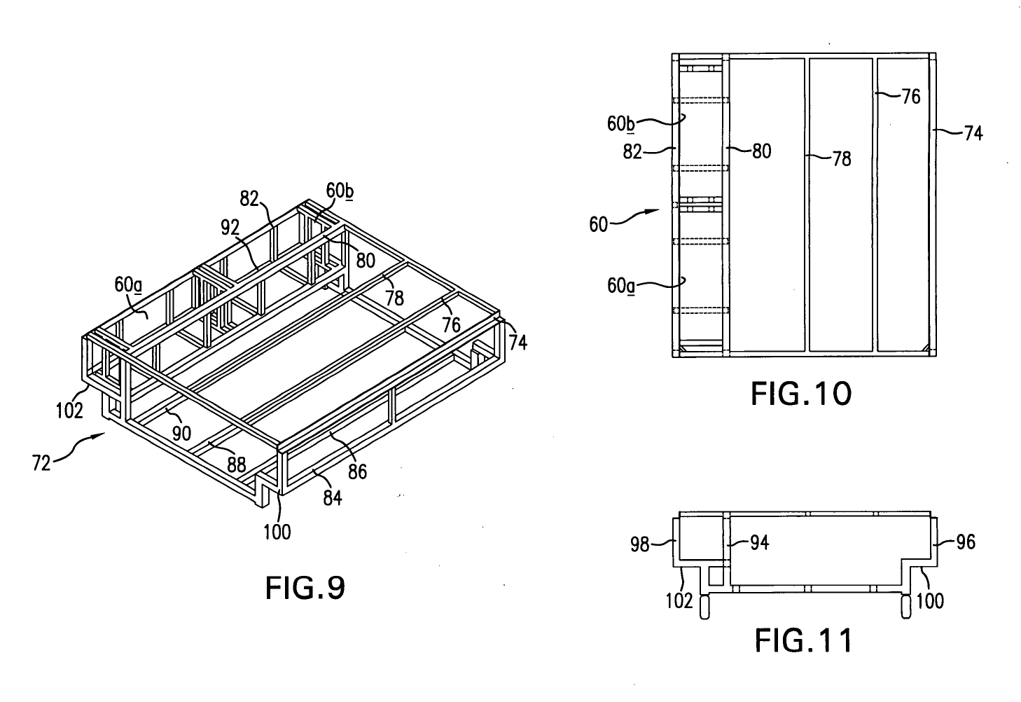

FIGS. 9-11 show the framework 72, made of sections of aluminum tubing, joined together by pop rivets or other mechanical fasteners, for organizer 10. The frame work is light, but strong, and has a rectangular outline when viewed from above, as in FIGS. 9 and 10. Parallel braces, or beams, 74, 76, 78, 80 and 82 extend across the top of the framework, while parallel traces 87, 86, 88, 90 and 92 extend across the bottom of the framework. The outline for insulated compartments 60a and 60b is visible, at the left of the organizer, in FIGS. 9 and 10. FIG. 11 shows vertical branch 94, and vertical walls 96, 98, that strengthen and rigidify framework 72. Rectangular notches or cut-outs 100, 102 are defined at the opposite sides of the organizer; the cut-outs enable the organizer to slide past the wheel wells into the body of the pick-up truck.

To illustrate, applicant's organizer can be used with full sized trucks, with long beds or short beds. The external layer, enclosing the framework, might be formed of vinyl or other impact resistant plastics. With some modification, the organizer might be reduced in size so that it could fit within the confines of an SUV.

Other modifications will occur to the skilled artisan from the foregoing description. Consequently, the appended claims should be broadly construed, consistent with the spirit and scope of the invention, and should not be strictly or literally construed.

I claim:

1. An organizer for storing supplies to be used at a party or event, said organizer adapted to fit into the bed at the rear of a pick-up truck;
a) said organizer comprising a top, a bottom, and side walls interconnecting said top and bottom;
b) said organizer being rectangular in shape when viewed from above;
c) said organizer being rectangular in shape when viewed in rear elevation;
d) the width of said organizer being slightly less than the width of the bed of a pick-up truck;
e) the height of said organizer being greater than the height of the side walls of a pick-up truck; and
f) at least one wheel secured to said bottom of said organizer at each corner so that said organizer can be moved longitudinally along the bed of a pick-up truck.

2. The organizer as defined in claim 1, further comprising an interior framework of tubular members secured together to define compartments of different dimensions.

3. The organizer as defined in claim 2, wherein doors are pivotally mounted at the rear of said organizer, said doors normally closing several, but not all, of said compartments.

4. The organizer as defined in claim 3, wherein a large rectangular opening is defined at the rear of said organizer below the several other compartments, said rectangular opening adapted to receive a large foldable table, and a strap secured across said opening to retain the table therein.

5. The organizer as defined in claim 2, wherein two components are defined at one side of said organizer, said compartments being U-shaped and opening upwardly, said compartments being insulated to store hot or cold beverages and/or hot or cold food.

6. The organizer as defined in claim 5, wherein at least one drain pipe extends through the insulation to allow condensate and other fluids to escape from said compartments to the exterior of said organizer.

7. The organizer as defined in claim 1, further including a platform to receive said organizer when said organizer is removed from the bed of a pick-up truck, said platform being of substantially the same height as the bed of a pick-up truck, and being of substantially the same size as said organizer.

8. The organizer as defined in claim 7, wherein said platform includes four legs, braces extending between said legs to stabilize same, and a pair of U-shaped channels secured to the tops of said legs.

9. The organizer as defined in claim 8, wherein said channels are spaced apart a sufficient distance to receive the wheels at the corners of said organizer, and allow the organizer to travel relative to said platform.

10. The organizer as defined in claim 9, wherein stops are formed at the ends of said channels to limit the movement of said organizer relative to said platform.

11. The organizer as defined in claim 9, wherein said legs have openings at their lower ends, and base members are inserted into said openings in a telescoping manner, the extent of insertion of said base members adjusting the height of said platform.

12. The organizer as defined in claim 11, wherein an enlarged pad is formed at the lower end of each base member to distribute by weight of the organizer, when resting atop said platform.
